(19) United States
(12) Patent Application Publication
(10) Pub. No.: US 2012/0034313 A1
(43) Pub. Date: Feb. 9, 2012

(54) Microbiocide/Sulfide Control Blends

(75) Inventors: Jodi Beth Wrangham, Stafford, TX (US); Sebastian D. Mancuso, Rosharon, TX (US)

(73) Assignee: Baker Hughes Incorporated, Houston, TX (US)

(21) Appl. No.: 13/048,464

(22) Filed: Mar. 15, 2011

Related U.S. Application Data
(60) Provisional application No. 61/371,261, filed on Aug. 6, 2010.

(51) Int. Cl. A01N 59/24; A01N 57/20; A01P 1/00; A01N 47/10; A01N 33/02; A01N 47/46; A01N 35/02; A01N 33/12

(52) U.S. Cl. 424/607; 514/705; 514/129; 514/642; 514/476; 514/701; 514/643; 514/579; 514/514

(57) ABSTRACT

A chemical blend that simultaneously kills bacteria and suppresses the production of hydrogen sulfide (H₂S) includes both a first chemical, which may be a glutaraldehyde, a tetrakishydroxymethyl phosphonium sulfate (THPS), a quaternary amine compound, a thiocyanate, a carbamate, a cinnamaldehyde, an alkyl dimethyl benzyl ammonium chloride, and/or a diamine diacetate; a second chemical which is a quinone; optionally a third chemical, which is a phosphate compound and a solvent which includes monoethylene glycol. The chemical blend has shown synergistic results for killing bacteria and/or suppressing the production of hydrogen sulfide as compared with the addition of the results of each of the components of the blend used separately.

### CROSS-REFERENCE TO RELATED APPLICATION

This application claims the benefit of U.S. Provisional Patent Application No. 61/371,261 filed Aug. 6, 2010, which is incorporated herein in its entirety by reference.

### TECHNICAL FIELD

The present invention relates to methods and compositions for killing bacteria and/or suppressing the production of hydrogen sulfide, and more particularly relates, in one non-limiting embodiment, to chemical blends that simultaneously kill bacteria and suppress the production of hydrogen sulfide.

### BACKGROUND

Hydrocarbon fluids, such as crude oil, crude oil emulsions, oilfield condensate, petroleum residua and sometimes even refined fuels often contain hydrogen sulfide (H₂S). H₂S is often generated downhole and in hydrocarbon-bearing subterranean formations by sulfate-reducing bacteria (SRB) that are naturally present. In the drilling, production, transport, storage, and processing of hydrocarbon stocks, the H₂S encountered may cause many problems ranging from malodors to metal corrosion. Because of the volatility of H₂S, which is of low molecular weight, it tends to evolve into vapor spaces, where its offensive odors create problems in and around storage areas and throughout pipelines and shipping systems used for transporting the hydrocarbon.

Bacterial contamination of drilling fluids themselves may contribute to a number of problems in the oil field. First, many of the muds contain sugar based polymers in their formulation that provide an effective food source to bacterial populations. This can lead to direct degradation of the mud. In addition, as noted, bacterial metabolism can generate deleterious products, particularly hydrogen sulfide which is not only a toxic gas, but may lead to decomposition of mud polymers, formation of problematic solids, such as iron sulfide, and/or corrosive action on drilling tubes and drilling hardware.

Various additives have been employed in efforts to alleviate these problems. Glutaraldehyde and alkyl dimethyl benzyl ammonium chloride are known biocides used for killing bacteria in these environments. Certain quinones are also known to inhibit sulfide production from sulfate-reducing bacteria in the oilfield.

Other additives are known to inhibit or remove H₂S and/or mercaptans after they are formed. For example, oil-soluble quaternary ammonium compounds have been known to scavenge H₂S and various sulfur compounds, including mercaptans, from certain oils, especially high boiling, heavy residual fuels. Other chemistries and methods for removing H₂S and mercaptans from hydrocarbons include caustic (NaOH solutions) and cobalt with caustic (Merox™ process of UOP, Merichem processes), as well as hexahydrotriazines.

It would be desirable to develop compositions and methods that would simultaneously kill bacteria and suppress the production of hydrogen sulfide in a fluid that is treated, for instance a drilling fluid or crude oil.

### SUMMARY

There is provided, in one non-limiting version, a chemical blend that is a microbiocide and also suppresses hydrogen sulfide when the blend is added to a fluid. The blend includes at least one first chemical, at least one second chemical, and a solvent that includes MEG. The at least one first chemical includes, but is not necessarily limited to, glutaraldehyde, tetrakishydroxymethyl phosphonium sulfate (THPS), a quaternary amine compound, a thiocyanate, a carbamate, a cinnamaldehyde, an alkyl dimethyl benzyl ammonium chloride, and/or a diamine diacetate. The at least one second chemical is a quinone, including but not necessarily limited to 9,10-anthrahydroquinone; 1,4-benzoquinone; and/or 1,8-dihydroxyanthraquinone. A required solvent is monoethylene glycol MEG, or a solvent package including monoethylene glycol.

In another non-restrictive embodiment, there is provided a method for simultaneously killing bacteria and suppressing the production of hydrogen sulfide in a fluid which involves adding to the fluid an effective amount of a chemical blend to simultaneously kill bacteria and suppress the production of hydrogen sulfide, where the chemical blend is as described above.

### DETAILED DESCRIPTION

The inventors have discovered that certain blends of at least a first chemical, at least a second quinone chemical, and a solvent that includes monoethylene glycol give synergistically better results at killing bacteria and/or suppressing the production of hydrogen sulfide as compared with the simple addition of the results of each of the components of the blend used separately or in blends having less than one of the three components.

The at least one first chemical may be a glutaraldehyde, a tetrakishydroxymethyl phosphonium sulfate (THPS), a quaternary amine compound, a thiocyanate, a carbamate, a cinnamaldehyde, an alkyl dimethyl benzyl ammonium chloride, a diamine diacetate, and combinations thereof. A suitable diamine diacetate includes, but is not necessarily limited to, cocodiamine diacetate. As previously noted, some of these are known biocides, including glutaraldehyde and alkyl dimethyl benzyl ammonium chloride (also known as ADBAC or benzalkonium chloride). Alkyl dimethyl benzyl ammonium chloride may have the following structure:

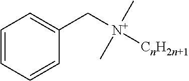

where n is from 8 to 18. THPS is known for iron sulfide scale removal.

The at least one second chemical may be a quinone. Suitable quinones include, but are not necessarily limited to, hydroquinones, benzoquinones, anthraquinones, and mixtures thereof. Suitable, more specific quinones include, but are not necessarily limited to, 9,10-anthrahydroquinone; 1,4-benzoquinone; and/or 1,8-dihydroxyanthraquinone.

In a non-limiting embodiment, at least one third chemical may be added to the chemical blend. The third chemical may be a phosphate compound. Suitable phosphate compounds include, but are not necessarily limited to, an ortho-phosphate, an ethoxylated phosphate, monosodium phosphate (NaH₂PO₄), a phosphate ester, a thio-phosphate ester, and mixtures thereof, and/or a scale inhibitor, such as a phosphate ester or phosphate salt. NaH₂PO₄ is known as a buffer. A suitable scale inhibitor may include, but is not necessarily limited to, AQUARITE ESL available from Rhodia. A suitable phosphate compound includes, but is not necessarily limited to, RHODAFAC PL6 available from Rhodia.

These blends are novel and unusual because it was previously thought that the first chemical, and the second chemical could not be combined into a single product without loss of activity or loss of stability. By ‘loss of stability’, it is meant that the components of the blended product would separate over time. Stability is achieved by a required solvent, which may include monoethylene glycol (MEG). The solvent may be a solvent package which includes MEG and may include other relatively low molecular weight alcohols and glycols, defined as those having six carbon atoms or less.

The proportions of the various components in the chemical blend may be as shown in the ranges of Table I. One non-limiting proportion range is given in the second column (First Range), whereas an alternative non-restrictive proportion range is given in the third column (Second Range). It will be appreciated that any lower threshold for a chemical may be combined with any upper threshold between the second column and the third column to give further alternative proportion ranges.

TABLE I
Proportion Ranges of Chemicals of Components
for the Blends, Vol %

| | | |
|---|---|---|
| Component | First Ranges | Second Ranges |

FIRST CHEMICAL

| | | |
|---|---|---|
| glutaraldehyde | about 10 to about 70, | about 20 to about 35, |
| | alternatively | alternatively |
| | about 10 to about 40 | about 10 to about 20 |
| THPS | about 10 to about 70 | about 20 to about 35 |
| quaternary amine | about 10 to about 70 | about 20 to about 35 |
| compound | | |
| thiocyanate | about 10 to about 70 | about 20 to about 35 |
| carbamate | about 10 to about 70 | about 20 to about 35 |
| cinnamaldehyde | about 10 to about 70 | about 20 to about 35 |
| alkyl dimethyl benzyl | about 10 to about 70 | about 20 to about 35, |
| ammonium chloride | alternatively | alternatively |
| | about 10 to about 40 | about 10 to about 20 |
| diamine diacetate | about 10 to about 70 | about 20 to about 35 |

SECOND CHEMICAL

| | | |
|---|---|---|
| Quinone | about 0.1 to about 10 | about 0.1 to about 5 |

Required SOLVENT

| | | |
|---|---|---|
| MEG | about 20 to about 80 | about 40 to about 75 |

THIRD CHEMICAL

| | | |
|---|---|---|
| NaH₂PO₄ | about 0.1 to about 80 | about 5 to about 60, |
| | | alternatively about 5 |
| | | to about 40 |
| ortho-phosphate | about 1 to about 25 | about 1 to about 10 |
| ethoxylated | about 1 to about 25 | about 1 to about 10 |
| phosphate | | |
| scale inhibitor | about 0.1 to about 20 | about 0.1 to about 7.5 |
| phosphate ester | about 1 to about 25 | about 1 to about 10 |
| thio-phosphate ester | from about 1 to about 25 | about 1 to about 10 |

Any combination using a first chemical, a second chemical, and a solvent may be used to practice this invention. However, particularly suitable combinations of first chemicals with second chemicals are expected to be the following:

a. glutaraldehyde,
NaH₂PO₄, and
a quinone selected from the group consisting of 9,10-anthrahydroquinone; 1,8-dihydroxyanthraquinone; 1,4-benzoquinone; and mixtures thereof, and
a solvent comprising MEG.

b. THPS,
NaH₂PO₄, and
a quinone selected from the group consisting of 9,10-anthrahydroquinone; 1,8-dihydroxyanthraquinone; 1,4-benzoquinone; and mixtures thereof, and
a solvent comprising MEG.

c. a quaternary amine compound,
a quinone selected from the group consisting of 9,10-anthrahydroquinone; 1,8-dihydroxyanthraquinone; 1,4-benzoquinone; and mixtures thereof,
an ortho-phosphate, and
a solvent comprising MEG.

d. alkyl dimethyl benzyl ammonium chloride,
a quinone selected from the group consisting of 9,10-anthrahydroquinone; 1,8-dihydroxyanthraquinone; 1,4-benzoquinone; and mixtures thereof, and
a solvent comprising MEG.

e. a diamine diacetate,
a quinone selected from the group consisting of 9,10-anthrahydroquinone; 1,8-dihydroxyanthraquinone; 1,4-benzoquinone; and mixtures thereof, and
a solvent comprising MEG.

f. a thiocyanate,
a quinone selected from the group consisting of 9,10-anthrahydroquinone; 1,8-dihydroxyanthraquinone; 1,4-benzoquinone; and mixtures thereof;
an ethoxylated phosphate; and
a solvent comprising MEG.

g. THPS,
a scale inhibitor,
NaH₂PO₄, and
a quinone selected from the group consisting of 9,10-anthrahydroquinone; 1,8-dihydroxyanthraquinone; 1,4-benzoquinone; and mixtures thereof, and
a solvent comprising MEG.

h. THPS, NaH₂PO₄, and
a quinone selected from the group consisting of 9,10-anthrahydroquinone; 1,8-dihydroxyanthraquinone; 1,4-benzoquinone; and mixtures thereof, and
a solvent comprising MEG.

i. THPS,
a phosphate ester, and
a quinone selected from the group consisting of 9,10-anthrahydroquinone; 1,8-dihydroxyanthraquinone; 1,4-benzoquinone; and mixtures thereof, and
a solvent comprising MEG.

j. THPS,
a scale inhibitor,
a phosphate ester, and
a quinone selected from the group consisting of 9,10-anthrahydroquinone; 1,8-dihydroxyanthraquinone; 1,4-benzoquinone; and mixtures thereof, and
a solvent comprising MEG.

k. cinnamaldehyde,
a quinone selected from the group consisting of 9,10-anthrahydroquinone; 1,8-dihydroxyanthraquinone; 1,4-benzoquinone; and mixtures thereof, and
a solvent comprising MEG.

In practicing the method using these chemical blends, an effective amount of a chemical blend to simultaneously kill bacteria and suppress the production of hydrogen sulfide will be added to the fluid. The exact amount of the chemical blend or range of effective amounts will be difficult to determine in advance and may require empirical methods to determine an optimal range or amount. For instance, an optimum range or amount may be affected by one or more factors including, but not necessarily limited to, the amount and type(s) of sulfate-reducing bacteria in the fluid, the temperature and pressure of the fluid, the chemical composition of the fluid and combinations of these effects. However, to give an idea of one representative effective proportion range, the chemical blend may be added to the fluid in an amount ranging from about 5 ppm to about 2000 ppm, alternatively from about 25 ppm to about 1000 ppm.

The fluids that may be treated with the chemical blends may be aqueous fluids, hydrocarbon fluids and combinations thereof, whether in a liquid state, gaseous state, or a combination thereof. Suitable fluids include, but are not necessarily limited to, crude oil, natural gas, condensate, oil-in-water emulsions, water-in-oil emulsions, drilling fluids, drill-in fluids, completion fluids, and the like.

It will be appreciated that it is not necessary for the chemical blend to kill all bacteria and/or completely suppress the production of H₂S for the methods described herein to be considered successful or effective, although such excellent results are desired and encompassed herein. The methods are considered successful and/or effective if more bacteria is killed and/or more H₂S production is suppressed, inhibited or controlled than would occur in the absence of the chemical blend.

It is expected that many of the chemical blends described herein will have synergistic efficacy at simultaneously killing bacteria and/or suppressing the production of H₂S as compared with simply the additive results of using the components of the blends used separately.

In the foregoing specification, the invention has been described with reference to specific embodiments thereof, and it is expected to be effective in simultaneously killing bacteria and suppressing the production of H₂S, as non-limiting examples. However, it will be evident that various modifications and changes can be made thereto without departing from the broader spirit or scope of the invention as set forth in the appended claims.

Accordingly, the specification is to be regarded in an illustrative rather than a restrictive sense. For example, specific first, second, and third chemicals, other than those specifically exemplified or mentioned, and/or in different proportions, falling within the claimed parameters, but not specifically identified or tried in a particular application to kill bacteria and/or suppress the production of H₂S, are within the scope of this invention. The terms “first chemical”, “second chemical”, and “third chemical” are used herein for the purpose of simplifying the categories of chemicals that may be added to the chemical blend and are not intended to limit the order by which the chemicals may be added to the chemical blend. The arrangement as listed within each combination is also not intended to limit the order by which the chemicals may be added to the chemical blend. More than one chemical may be used from the first chemical group and/or from the second chemical group. The third chemical is not necessary to practice the invention, but may be added to the chemical blend to enhance the efficacy of the chemical blend for killing and/or suppressing the production of H₂S. Similarly, it is expected that the inventive compositions will find utility in killing bacteria and/or for suppressing the production of H₂S for other fluids besides crude oil.

The terms “comprises” and “comprising” in the claims should be interpreted to mean including, but not limited to, the recited elements.

The present invention may suitably comprise, consist or consist essentially of the elements disclosed and may be practiced in the absence of an element not disclosed. For instance, a chemical blend may consist of or consist essentially of at least one first chemical, at least one second, quinone chemical, at least one third, phosphate chemical and optionally a solvent, as defined in the claims. Similarly, methods for simultaneously killing bacteria and suppressing production of H₂S may use a chemical blend that consists of or consists essentially of at least one first chemical, at least one second chemical that is a quinone, and a solvent, as defined in the claims.

What is claimed is:

1. A method for simultaneously killing bacteria and suppressing the production of hydrogen sulfide in a fluid comprising adding to the fluid an effective amount of a chemical blend to simultaneously kill bacteria and suppress the production of hydrogen sulfide, the chemical blend comprising:
at least one first chemical selected from the group consisting of a glutaraldehyde, a tetrakishydroxymethyl phosphonium sulfate (THPS), a quaternary amine compound, a thiocyanate, a carbamate, a cinnamaldehyde, an alkyl dimethyl benzyl ammonium chloride, a diamine diacetate, and mixtures thereof;
at least one second chemical that is a quinone; and
a solvent comprising monoethylene glycol.

2. The method of claim 1 where if the indicated chemical is included in the chemical blend, it is included in the indicated proportion based on the total chemical blend:
for the at least one first chemical:
glutaraldehyde—from about 10 to about 70 vol %;
THPS—from about 10 to about 70 vol %;
alkyl dimethyl benzyl ammonium chloride—from about 10 to about 70 vol %;
diamine diacetate—from about 10 to about 70 vol %;
a quaternary amine compound—from about 10 to about 70 vol %;
a thiocyanate—from about 10 to about 70 vol %;
a carbamate—from about 10 to about 70 vol %;
a cinnamaldehyde—from about 10 to about 70 vol %;
for the at least one second chemical that is a quinone—from about 0.1 to about 10 vol %; and
for the solvent—from about 20 to about 80 vol %.

3. The method of claim 1 where in the at least one second chemical is selected from the group consisting of 9,10-anthrahydroquinone; 1,4-benzoquinone; 1,8-dihydroxyanthraquinone; and mixtures thereof.

4. The method of claim 1 further comprising at least one third chemical that is a phosphate compound.

5. The method of claim 4 where the chemical blend further comprises at least one third chemical selected from the group consisting of an ortho-phosphate, an ethoxylated phosphate, a monosodium phosphate (NaH₂PO₄), a scale inhibitor, a phosphate ester, a thio-phosphate ester, and mixtures thereof.

6. The method of claim 5 where the indicated third chemical is included in the indicated proportion based on the total chemical blend:
an ortho-phosphate—from about 1 to about 25 vol %;
an ethoxylated phosphate—from about 1 to about 25 vol %;
NaH₂PO₄—from about 0.1 to about 80 vol %;
a thio-phosphate ester—from about 1 to about 25 vol %;
scale inhibitor—from about 0.1 to about 20 vol %; and
phosphate ester—from about 1 to about 25 vol %.

7. The method of claim 5, where the chemical blend is selected from the group consisting of:
a. glutaraldehyde,
NaH₂PO₄, and
a quinone selected from the group consisting of 9,10-anthrahydroquinone; 1,8-dihydroxyanthraquinone; 1,4-benzoquinone; and mixtures thereof; and
a solvent comprising monoethylene glycol;
b. THPS,
NaH₂PO₄, and
a quinone selected from the group consisting of 9,10-anthrahydroquinone; 1,8-dihydroxyanthraquinone; 1,4-benzoquinone; and mixtures thereof; and
a solvent comprising monoethylene glycol;
c. a quaternary amine compound,
a quinone selected from the group consisting of 9,10-anthrahydroquinone; 1,8-dihydroxyanthraquinone; 1,4-benzoquinone; and mixtures thereof,
an ortho-phosphate, and
a solvent comprising monoethylene glycol;
d. alkyl dimethyl benzyl ammonium chloride,
a quinone selected from the group consisting of 9,10-anthrahydroquinone; 1,8-dihydroxyanthraquinone; 1,4-benzoquinone; and mixtures thereof; and
a solvent comprising monoethylene glycol;
e. a diamine diacetate,
a quinone selected from the group consisting of 9,10-anthrahydroquinone; 1,8-dihydroxyanthraquinone; 1,4-benzoquinone; and mixtures thereof; and
a solvent comprising monoethylene glycol;
f. a thiocyanate,
a quinone selected from the group consisting of 9,10-anthrahydroquinone; 1,8-dihydroxyanthraquinone; 1,4-benzoquinone; and mixtures thereof;
ethoxylated phosphate; and
a solvent comprising monoethylene glycol;
g. THPS,
a scale inhibitor,
NaH₂PO₄, and
a quinone selected from the group consisting of 9,10-anthrahydroquinone; 1,8-dihydroxyanthraquinone; 1,4-benzoquinone; and mixtures thereof; and
a solvent comprising monoethylene glycol;
h. THPS,
NaH₂PO₄, and
a quinone selected from the group consisting of 9,10-anthrahydroquinone; 1,8-dihydroxyanthraquinone; 1,4-benzoquinone; and mixtures thereof; and
a solvent comprising monoethylene glycol;
i. THPS,
a phosphate ester, and
a quinone selected from the group consisting of 9,10-anthrahydroquinone; 1,8-dihydroxyanthraquinone; 1,4-benzoquinone; and mixtures thereof; and
a solvent comprising monoethylene glycol;
j. THPS,
a scale inhibitor,
a phosphate ester, and
a quinone selected from the group consisting of 9,10-anthrahydroquinone; 1,8-dihydroxyanthraquinone; 1,4-benzoquinone; and mixtures thereof; and
a solvent comprising monoethylene glycol;
k. cinnamaldehyde;
a quinone selected from the group consisting of 9,10-anthrahydroquinone; 1,8-dihydroxyanthraquinone; 1,4-benzoquinone; and mixtures thereof; and
a solvent comprising monoethylene glycol.

8. The method of claim 5, where the chemical blend is selected from the group consisting of:
a. from about 10 to about 70 vol % glutaraldehyde,
from about 0.1 to about 80 vol % NaH₂PO₄, and
from about 0.1 to about 10 vol % of a quinone selected from the group consisting of 9,10-anthrahydroquinone; 1,8-dihydroxyanthraquinone; 1,4-benzoquinone; and mixtures thereof; and
from about 20 to about 80 vol % of a solvent comprising monoethylene glycol;
b. from about 10 to about 70 vol % THPS,
from about 0.1 to about 80 vol % NaH₂PO₄, and
from about 0.1 to about 10 vol % of a quinone selected from the group consisting of 9,10-anthrahydroquinone; 1,8-dihydroxyanthraquinone; 1,4-benzoquinone; and mixtures thereof; and
from about 20 to about 80 vol % of a solvent comprising monoethylene glycol;
c. from about 10 to about 70 vol % of a quaternary amine compound,
from about 0.1 to about 10 vol % of a quinone selected from the group consisting of 9,10-anthrahydroquinone; 1,8-dihydroxyanthraquinone; 1,4-benzoquinone; and mixtures thereof;
from about 1 to about 25 vol % of an ortho-phosphate, and
from about 20 to about 80 vol % of a solvent comprising monoethylene glycol;
d. from about 10 to about 70 vol % alkyl dimethyl benzyl ammonium chloride,
from about 0.1 to about 10 vol % of a quinone selected from the group consisting of 9,10-anthrahydroquinone; 1,8-dihydroxyanthraquinone; 1,4-benzoquinone; and mixtures thereof; and
from about 20 to about 80 vol % of a solvent comprising monoethylene glycol;
e. from about 10 to about 70 vol % of a diamine diacetate,
from about 0.1 to about 10 vol % of a quinone selected from the group consisting of 9,10-anthrahydroquinone; 1,8-dihydroxyanthraquinone; 1,4-benzoquinone; and mixtures thereof; and
from about 20 to about 80 vol % of a solvent comprising monoethylene glycol;
f. from about 10 to about 70 vol % of a thiocyanate,
from about 0.1 to about 10 vol % of a quinone selected from the group consisting of 9,10-anthrahydroquinone; 1,8-dihydroxyanthraquinone; 1,4-benzoquinone; and mixtures thereof;
from about 1 to about 25 vol % of an ethoxylated phosphate; and
from about 20 to about 80% of a solvent comprising monoethylene glycol;
g. from about 10 to about 70 vol % THPS,
from about 0.1 to about 20 vol % of a scale inhibitor,
from about 0.1 to about 80 vol % NaH₂PO₄, and
from about 0.1 to about 10 vol % of a quinone selected from the group consisting of 9,10-anthrahydroquinone; 1,8-dihydroxyanthraquinone; 1,4-benzoquinone; and mixtures thereof; and
from about 20 to about 80 vol % of a solvent comprising monoethylene glycol;
h. from about 10 to about 70 vol % THPS,
from about 0.1 to about 80 vol % NaH₂PO₄, and
from about 0.1 to about 10 vol % of a quinone selected from the group consisting of 9,10-anthrahydroquinone; 1,8-dihydroxyanthraquinone; 1,4-benzoquinone; and mixtures thereof; and
from about 20 to about 80 vol % of a solvent comprising monoethylene glycol;
i. from about 10 to about 70 vol % THPS,
from about 1 to about 25 vol % a phosphate ester, and
from about 0.1 to about 10 vol % of a quinone selected from the group consisting of 9,10-anthrahydroquinone; 1,8-dihydroxyanthraquinone; 1,4-benzoquinone; and mixtures thereof, and
from about 20 to about 80 vol % of a solvent comprising monoethylene glycol;
j. from about 10 to about 70 vol % THPS,
from about 0.1 to about 20 vol % of a scale inhibitor,
from about 1 to about 25 vol % a phosphate ester, and
from about 0.1 to about 10 vol % of a quinone selected from the group consisting of 9,10-anthrahydroquinone; 1,8-dihydroxyanthraquinone; 1,4-benzoquinone; and mixtures thereof; and
from about 20 to about 80 vol % of a solvent comprising monoethylene glycol;
k. from about 10 to about 70 vol % of a cinnamaldehyde;
from about 0.1 to about 10 vol % of a quinone selected from the group consisting of 9,10-anthrahydroquinone; 1,8-dihydroxyanthraquinone; 1,4-benzoquinone; and mixtures thereof; and
from about 20 to about 80 vol % of a solvent comprising monoethylene glycol.

9. The method of claim 1 where the fluid is selected from aqueous fluids, hydrocarbon fluids and combinations thereof, whether in a liquid state, gaseous state, or a combination thereof.

10. The method of claim 1 where the effective amount of the chemical blend added to the fluid ranges from about 5 ppm to about 2000 ppm.

11. A method for simultaneously killing bacteria and suppressing the production of hydrogen sulfide in a fluid comprising adding to the fluid an effective amount of a chemical blend to simultaneously kill bacteria and suppress the production of hydrogen sulfide, the chemical blend comprising:
at least one first chemical selected from the group consisting of a glutaraldehyde, a tetrakishydroxymethyl phosphonium sulfate (THPS), a quaternary amine compound, a thiocyanate, a carbamate, a cinnamaldehyde, an alkyl dimethyl benzyl ammonium chloride, a diamine diacetates, and mixtures thereof;
at least one second chemical that is a quinone selected from the group consisting of hydroquinones, benzoquinones, anthraquinones and mixtures thereof; and
at least one third chemical that is a phosphate compound; and a solvent comprising monoethylene glycol.

12. A chemical blend that is a microbiocide and also suppresses hydrogen sulfide, the blend comprising:
at least one first chemical selected from the group consisting of a glutaraldehyde, a tetrakishydroxymethyl phosphonium sulfate (THPS), a quaternary amine compound, a thiocyanate, a carbamate, a cinnamaldehyde, an alkyl dimethyl benzyl ammonium chloride, a diamine diacetates, and mixtures thereof;
at least one second chemical that is a quinone; and
a solvent comprising monoethylene glycol.

13. The chemical blend of claim 12 where if the indicated chemical is included, it is included in the indicated proportion based on the total chemical blend:
for the at least one first chemical:
glutaraldehyde—from about 10 to about 70 vol %;
THPS—from about 10 to about 70 vol %;
a quaternary amine compound—from about 10 to about 70 vol %;
a thiocyanate—from about 10 to about 70 vol %;
a carbamate—from about 10 to about 70 vol %;
a cinnamaldehyde—from about 10 to about 70 vol %;
alkyl dimethyl benzyl ammonium chloride—from about 10 to about 70 vol %;
diamine diacetate—from about 10 to about 70 vol %;
for the at least one second chemical that is a quinone—from about 0.1 to about 10 vol %; and
for the monoethylene glycol—from about 20 to about 80 vol %.

14. The chemical blend of claim 12 where the quinone is selected from the group consisting of 9,10-anthrahydroquinone; 1,4-benzoquinone; 1,8-dihydroxyanthraquinone; and mixtures thereof.

15. The chemical blend of claim 12 further comprising at least one third chemical that is a phosphate compound.

16. The chemical blend of claim 15 further comprising at least one third chemical selected from the group consisting of an ortho-phosphate, an ethoxylated phosphate, a monosodium phosphate (NaH₂PO₄), a phosphate ester, a thio-phosphate ester, a scale inhibitor, a phosphate ester, and mixtures thereof.

17. The chemical blend of claim 16 where the indicated third chemical is included in the indicated proportion based on the total chemical blend:
an ortho-phosphate—from about 1 to about 25 vol %;
an ethoxylated phosphate—from about 1 to about 25 vol %;
a phosphate ester—from about 1 to about 25 vol %;
a thio-phosphate ester—from about 1 to about 25 vol %;
NaH₂PO₄—from about 0.1 to about 80 vol %;
scale inhibitor—from about 0.1 to about 20 vol %; and
phosphate ester—from about 1 to about 25 vol %.

18. The chemical blend of claim 16, where the chemical blend is selected from the group consisting of:
a. glutaraldehyde,
NaH₂PO₄, and
a quinone selected from the group consisting of 9,10-anthrahydroquinone; 1,8-dihydroxyanthraquinone; 1,4-benzoquinone; and mixtures thereof; and
a solvent comprising monoethylene glycol;
b. THPS,
NaH₂PO₄, and
a quinone selected from the group consisting of 9,10-anthrahydroquinone; 1,8-dihydroxyanthraquinone; 1,4-benzoquinone; and mixtures thereof; and
a solvent comprising monoethylene glycol;
c. a quaternary amine compound,
a quinone selected from the group consisting of 9,10-anthrahydroquinone; 1,8-dihydroxyanthraquinone; 1,4-benzoquinone; and mixtures thereof,
an ortho-phosphate, and
a solvent comprising monoethylene glycol;
d. an alkyl dimethyl benzyl ammonium chloride,
a quinone selected from the group consisting of 9,10-anthrahydroquinone; 1,8-dihydroxyanthraquinone; 1,4-benzoquinone; and mixtures thereof; and
a solvent comprising monoethylene glycol;
e. diamine diacetate,
a quinone selected from the group consisting of 9,10-anthrahydroquinone; 1,8-dihydroxyanthraquinone; 1,4-benzoquinone; and mixtures thereof; and
a solvent comprising monoethylene glycol;
f. thiocyanate,
a quinone selected from the group consisting of 9,10-anthrahydroquinone; 1,8-dihydroxyanthraquinone; 1,4-benzoquinone; and mixtures thereof;
ethoxylated phosphate; and
a solvent comprising monoethylene glycol;
g. THPS,
a scale inhibitor,
NaH₂PO₄, and
a quinone selected from the group consisting of 9,10-anthrahydroquinone; 1,8-dihydroxyanthraquinone; 1,4-benzoquinone; and mixtures thereof; and
a solvent comprising monoethylene glycol;
h. THPS,
NaH₂PO₄, and
a quinone selected from the group consisting of 9,10-anthrahydroquinone; 1,8-dihydroxyanthraquinone; 1,4-benzoquinone; and mixtures thereof; and
a solvent comprising monoethylene glycol;
i. THPS,
a phosphate ester, and
a quinone selected from the group consisting of 9,10-anthrahydroquinone; 1,8-dihydroxyanthraquinone; 1,4-benzoquinone; and mixtures thereof; and
from about 20 to about 80% of a solvent comprising monoethylene glycol;
j. THPS,
a scale inhibitor,
a phosphate ester, and
a quinone selected from the group consisting of 9,10-anthrahydroquinone; 1,8-dihydroxyanthraquinone; 1,4-benzoquinone; and mixtures thereof; and
a solvent comprising monoethylene glycol;
k. cinnamaldehyde,
a quinone selected from the group consisting of 9,10-anthrahydroquinone; 1,8-dihydroxyanthraquinone; 1,4-benzoquinone; and mixtures thereof, and
a solvent comprising monoethylene glycol.

19. The chemical blend of claim 16, where the chemical blend is selected from the group consisting of:
a. from about 10 to about 70 vol % glutaraldehyde,
from about 0.1 to about 80 vol % NaH₂PO₄, and
from about 0.1 to about 10 vol % of a quinone selected from the group consisting of 9,10-anthrahydroquinone; 1,8-dihydroxyanthraquinone; 1,4-benzoquinone; and mixtures thereof; and
from about 20 to about 80 vol % of a solvent comprising monoethylene glycol;
b. from about 10 to about 70 vol % THPS,
from about 0.1 to about 80 vol % NaH₂PO₄, and
from about 0.1 to about 10 vol % of a quinone selected from the group consisting of 9,10-anthrahydroquinone; 1,8-dihydroxyanthraquinone; 1,4-benzoquinone; and mixtures thereof; and
from about 20 to about 80 vol % of a solvent comprising monoethylene glycol;
c. from about 10 to about 70 vol % of a quaternary amine compound,
from about 0.1 to about 10 vol % of a quinone selected from the group consisting of 9,10-anthrahydroquinone; 1,8-dihydroxyanthraquinone; 1,4-benzoquinone; and mixtures thereof,
from about 1 to about 25 vol % of an ortho-phosphate, and
from about 20 to about 80 vol % of a solvent comprising monoethylene glycol;
d. from about 10 to about 70 vol % alkyl dimethyl benzyl ammonium chloride,
from about 0.1 to about 10 vol % of a quinone selected from the group consisting of 9,10-anthrahydroquinone; 1,8-dihydroxyanthraquinone; 1,4-benzoquinone; and mixtures thereof; and
from about 20 to about 80 vol % of a solvent comprising monoethylene glycol;
e. from about 10 to about 70 vol % of a diamine diacetate,
from about 0.1 to about 10 vol % of a quinone selected from the group consisting of 9,10-anthrahydroquinone; 1,8-dihydroxyanthraquinone; 1,4-benzoquinone; and mixtures thereof; and
from about 20 to about 80 vol % of a solvent comprising monoethylene glycol;
f. from about 10 to about 70 vol % of a thiocyanate,
from about 0.1 to about 10 vol % of a quinone selected from the group consisting of 9,10-anthrahydroquinone; 1,8-dihydroxyanthraquinone; 1,4-benzoquinone; and mixtures thereof;
from about 1 to about 25 vol % of an ethoxylated phosphate; and
from about 20 to about 80 vol % of a solvent comprising monoethylene glycol;
g. from about 10 to about 70 vol % THPS,
from about 0.1 to about 20 vol % a scale inhibitor,
from about 0.1 to about 80 vol % NaH₂PO₄, and
from about 0.1 to about 10 vol % of a quinone selected from the group consisting of 9,10-anthrahydroquinone; 1,8-dihydroxyanthraquinone; 1,4-benzoquinone; and mixtures thereof; and
from about 20 to about 80 vol % of a solvent comprising monoethylene glycol;
h. from about 10 to about 70 vol % THPS,
from about 0.1 to about 80 vol % NaH₂PO₄, and
from about 0.1 to about 10 vol % of a quinone selected from the group consisting of 9,10-anthrahydroquinone; 1,8-dihydroxyanthraquinone; 1,4-benzoquinone; and mixtures thereof; and
from about 20 to about 80 vol % of a solvent comprising monoethylene glycol;
i. from about 10 to about 70 vol % THPS,
from about 1 to about 25 vol % a phosphate ester, and
from about 0.1 to about 10 vol % of a quinone selected from the group consisting of 9,10-anthrahydroquinone; 1,8-dihydroxyanthraquinone; 1,4-benzoquinone; and mixtures thereof; and
from about 20 to about 80 vol % of a solvent comprising monoethylene glycol;
j. from about 10 to about 70 vol % THPS,
from about 0.1 to about 20 vol % a scale inhibitor,
from about 1 to about 25 vol % a phosphate ester, and
from about 0.1 to about 10 vol % of a quinone selected from the group consisting of 9,10-anthrahydroquinone; 1,8-dihydroxyanthraquinone; 1,4-benzoquinone; and mixtures thereof; and
from about 20 to about 80 vol % of a solvent comprising monoethylene glycol; and
k. from about 10 to about 70 vol % of a cinnamaldehyde;
from about 0.1 to about 10 vol % of a quinone selected from the group consisting of 9,10-anthrahydroquinone; 1,8-dihydroxyanthraquinone; 1,4-benzoquinone; and mixtures thereof; and
from about 20 to about 80 vol % of a solvent comprising monoethylene glycol.

20. A chemical blend that is a microbiocide and also suppresses hydrogen sulfide, the blend comprising:
at least one first chemical selected from the group consisting of a glutaraldehyde, a tetrakishydroxymethyl phosphonium sulfate (THPS), a quaternary amine compound, a thiocyanate, a carbamate, a cinnamaldehyde, an alkyl dimethyl benzyl ammonium chloride, a diamine diacetate, and mixtures thereof;
at least one second chemical that is a quinone selected from the group consisting of hydroquinones, benzoquinones, anthraquinones and mixtures thereof; and
at least one third chemical that is a phosphate compound; and
a solvent comprising monoethylene glycol.
